(19) United States
(12) Patent Application Publication
(10) Pub. No.: US 2013/0337030 A1
(43) Pub. Date: Dec. 19, 2013

(54) NEUTRALLY BUOYANT INGESTIBLE COMPOSITIONS

(71) Applicants: Georgius Abidal Adam, Edensor Park (AU); Michael Keoni Manion, Cornulla (AU)

(72) Inventors: Georgius Abidal Adam, Edensor Park (AU); Michael Keoni Manion, Cornulla (AU)

(73) Assignee: EMPIRE TECHNOLOGY DEVELOPMENT LLC, Wilmington, DE (US)

(21) Appl. No.: 13/825,475

(22) PCT Filed: Jun. 14, 2012
(86) PCT No.: PCT/US12/42366

§ 371 Date: Mar. 21, 2013

(51) Int. Cl. A23K 1/00; A01K 61/02

(52) U.S. Cl. CPC A23K 1/004; A01K 61/02
USPC 424/442; 426/531; 426/658; 426/601; 426/656; 426/72; 426/648; 426/89; 426/473; 426/302; 426/2; 514/52; 264/160; 264/232; 427/212; 119/230

(57) ABSTRACT

A nutriment or medicament may have a neutral buoyancy for being suspended in a liquid, or at a desired depth within the liquid to improve consumption of the nutriment or medicament and reduce waste. Disclosed also are methods for making and using the neutrally buoyant products.

### BACKGROUND

Current animal farming practices can often involve very large numbers of animals raised in limited space. Farmed animals require large amounts of food, water and medicine to keep the animals healthy. However, ensuring that animals take in the nutrients needed to remain healthy is often challenging, as the animals may not always consume a quantity necessary for proper nutrition. Further, the feeding of livestock is subject to problems such as food spoilage and wastage, leading to contamination and undesirable odors.

One of the fastest growing sectors in animal farming is aquaculture, or aquafarming Aquaculture is the farming of aquatic organisms such as fish, crustaceans, mollusks and aquatic plants. Some of the aquatic species which are commonly farmed include carp, oysters, clams, shrimp, salmon, tilapia and trout. Worldwide, the growth rate of aquaculture has been sustained and rapid, averaging about 8% per annum for over thirty years. The aquaculture market reached $86 billion in 2009. Aquaculture is an especially important economic activity in China. Between 1980 and 1997, the Chinese Bureau of Fisheries reported that aquaculture harvests grew at an annual rate of 16.7%, jumping from 1,900,000 tons to nearly 23,000,000 tons. In 2005, China accounted for 70% of world production of farmed fish. Aquaculture is also currently one of the fastest growing areas of food production in the U.S.

It has been estimated that up to about one half of the world supply of fish and shellfish processed for human consumption is now produced by aquaculture. Current methods of aquaculture, however, either land-based or mariculture, can cause significant ecological damage by releasing nutrients and pollutants into the surrounding environment. Some of the main causes of pollution from aquaculture are due to the excess feed given to the fish. An excess will generally be provided to ensure that the fish have enough to eat while allowing for losses due to food which settles to the bottom or floating food which may be eaten by birds, for example. The settling of nutrient rich material attracts bacteria and other contaminants, and can lead to fouling of the water, especially in tank-based systems. One method of controlling the bacteria is by using chemicals, but the chemicals themselves can be harmful to the environment.

It is therefore desirable to have a nutrition/medicine source which remains at a desired position or depth in a water column.

### SUMMARY

Presently disclosed is a food or medication source which is configured to match the buoyancy of the liquid into which it is to be dispersed so that the food/medication remains suspended at a particular depth in the liquid. A density of the liquid may be determined for a particular depth, and the food/medication may be constructed to have a matching density to buoyantly suspend the food/medication in the liquid.

In an embodiment, a solid ingestible composition is configured to be dispersed in an aqueous solution. The ingestible composition is configured to have a density for buoyantly suspending the ingestible composition at a depth below the surface of the aqueous solution.

In an embodiment, a kit for aquatic animal farming of at least first and second aquatic animal species includes a first food for the first aquatic animal species having a preferred first feeding depth below the surface of the water; and a second food for the second aquatic animal species having a preferred second feeding depth below the surface of the water. The first food is configured to have a first density for buoyantly suspending the first food at the first depth and the second food is configured to have a second density for buoyantly suspending the second food at the second depth.

In an embodiment, a method for producing a solid ingestible composition that is configured to be suspended in an aqueous solution at a depth below the surface of the aqueous solution includes determining a density of the aqueous solution at the suspension depth, and forming the ingestible composition to have a density equal to the density of the aqueous solution at the suspension depth for buoyantly suspending the ingestible composition at the suspension depth.

In an embodiment, a method for providing nourishment to animals includes determining a density of an aqueous solution, and combining at least a first solid ingestible component with the aqueous solution. The first solid ingestible component has a density equal to the density of the aqueous solution to buoyantly suspend the first solid ingestible component within the aqueous solution. The first solid ingestible component is at least one of a nutriment and a medicament.

### BRIEF DESCRIPTION OF THE FIGURES

FIG. 1 shows a density profile of a lake in relation to depth of the lake.

FIG. 2 depicts the feeding of fish with neutrally buoyant fish foods according to an embodiment.

FIG. 3 depicts an embodiment of a neutrally buoyant food or medicine.

FIG. 4 depicts an alternative embodiment of a neutrally buoyant food or medicine.

FIG. 5 depicts an embodiment of an encapsulated neutrally buoyant food or medicine.

FIG. 6 depicts an alternative embodiment of an encapsulated neutrally buoyant food or medicine.

FIG. 7 shows an illustrative system for producing a neutrally buoyant food or medicine according to an embodiment.

### DETAILED DESCRIPTION

The efficient feeding of farmed animals presents several challenges to the farmer. The farmer must ensure that an adequate supply of food is on hand so that food may be presented for consumption at regular intervals. If the supply is inadequate, the animals may not get the food they need, and if the supply is too large, food may become spoiled and unsuitable to feed the animals. Spoiled food may contaminate good food and may lead to undesirable odors or create health challenges. The farmer must also be knowledgeable in the eating habits of the animals so that the food is distributed to the animals in a manner in which the animals prefer to consume the food, and an adequate amount is provided for consumption, without providing too much which may go to waste, or attract and be eaten by undesirable animals, such as rodents and other wild animals.

Ensuring that animals take in the nutrients that they need to remain healthy is often challenging, as they may not always consume a quantity necessary for proper nutrition. Due to seasonal changes, and natural growth cycles, the animals may require different amounts of food throughout the year, and the farmer must be observant of the consumption to note if the animals are consuming as they should be to maintain proper nutrition and health. For example, in hot weather, in particular, it is known that the weight gain of livestock such as beef cattle is slowed, as the animals prefer to drink rather than to eat, and it may be difficult to increase intake of calories via solid food consumption. In such instances, it may be desirable to add nutrient supplements to the water supply to supplement the food sources to ensure that the cattle consume a sufficient amount of calories to continue to grow and remain healthy through the hotter seasons. If such a supplement floated on the water surface, the cattle may refuse to drink the water, while on the other hand, if the supplement settled out of the water, it would go to waste on the bottom of the watering trough. Similarly, when medicaments or supplements are added to a water supply, the animals may be able to taste, or smell the medicines, and refuse to consume the water.

Aquafarming requires many of the same considerations. An aquafarmer must understand the aquatic environment and maintain proper water conditions for support of the animals. Food for aquatic animals often settles through the water after it is dispersed for consumption, and fish may eat the food as it settles downwardly. A portion of the food almost always will settle to the bottom uneaten. Fish generally do not consume the settled food at the same rate as food which is suspended in the water. Often, the settled food may not be consumed and it may just sit on the bottom where it will deteriorate and become wasted. Typical feeding amounts therefore often need to include a portion that is allotted for waste, and tanks need to be regularly flushed to remove the fouling, settled food, resulting in a release of these materials to the surrounding environment, and thereby negatively impacting the local ecology.

Some fish foods float on the top of the water and some species of fish may not eat floating food. In addition, floating food often attracts other animals as well, such as waterfowl and other birds, which may result in water fouling from bird excrement as well. Again, a portion of the food must be allotted as waste as it may be consumed by unfarmed animals.

There are other factors which may also need to be taken into consideration. For some species of fish, the fish may prefer different feeding depths depending on the stage of their development. Young fish (fingerlings) may prefer to feed just below the water surface, while fully mature fish may prefer deeper water. Some species of fish may only consume food which is located at a certain feeding depth, ignoring food which is located on the surface, or which has settled to the bottom, or which may be floating at a depth at which that species does not normally inhabit. In addition, aquatic animal foods and medicines may also be rejected by the aquatic animals if they do not like the smell or taste.

To overcome some of the problems associated with animal nourishment, the food and medicines may be incorporated into formulations which mask the taste and/or smell, and which remain suspended in the water so that they are readily consumed by the animals for which they are intended. In an embodiment, ingestible compositions, such as nutriments and/or medicaments may be formulated to have a matching density of the liquid, or neutral buoyancy in the liquid in which they are to be dispersed, so that they remain suspended in the liquid and available for consumption by the animals for which they are intended. For various aquatic species that prefer feeding at different depths, the ingestible compositions may be formulated with densities that match the density or buoyancy of the water at the preferred feeding depth.

The density of water tends to increase with depth which means that each depth has a unique density, whereby ‘density layers’ are created between the surface and the bottom. Three factors combine to create this density gradient: dissolved or suspended constituents, temperature and pressure. Dissolved constituents, such as salt (salinity), may increase with depth, while temperature may decrease with depth. Both of these factors result in an increase in density with depth. Pressure also increases with depth, and since water is compressible, the density of water also increases with increased pressure.

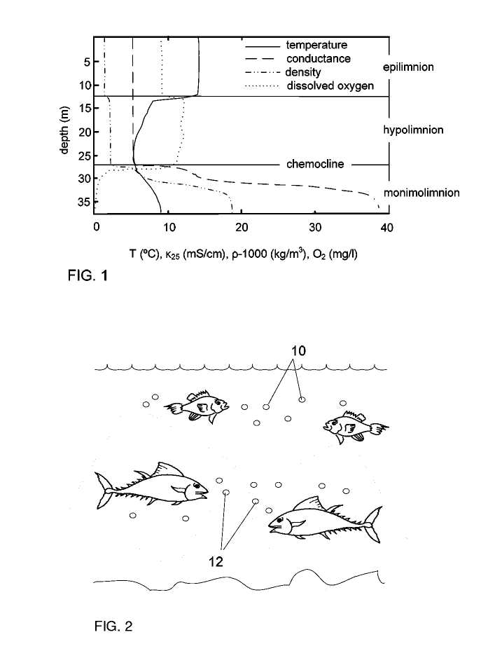

One example of density layers in a lake is depicted in FIG. 1 which shows a density profile for the Rassnitzer Sea. An upper, warmer surface layer, termed the epilimnion, has a density of about 1.0011 g/cm³ and extends to about 12.5 meters below the surface. A next lower layer, termed the hypolimnion, has a density of about 1.0018 g/cm³ and extends from about 12.5 meters to about 27 meters. A bottom layer, termed the monimolimnion, shows a significant change in density from about 1.0018 g/cm³ to about 1.0185 g/cm³ within the next 6 meters of depth. The density of water may be from about 1.000 g/cm³ for fresh water to about 1.05 g/cm³ for sea water.

In general, when an object is placed in a fluid, the object experiences an upward force equal to the weight of fluid displaced. This buoyancy force therefore acts in the opposite direction of gravity and causes an object to essentially weigh less when in the fluid. When an object is placed in water, an amount, or volume, of the water is displaced as a function of the ‘size’ of the object. In a simple case, without taking into account the shape of the object, if the weight of the displaced water is more than the weight of the object, the object will generally float, and is said to be positively buoyant. If the weight of the displaced water is less than the weight to the object, the object will generally sink, and is said to be negatively buoyant. And, if the weight of the displaced water is the same as the weight of the object, the object will essentially hover, and is said to be neutrally buoyant.

Thus, buoyancy is related to the weight and volume, or density, of the object. In addition, the shape of the object has an effect on the buoyancy. The shape of an object determines how much of its surface (in relation to its volume) is exposed to the forces of water, in particular pressure and buoyancy. For an object having a large surface area in one dimension as opposed to another, the object may float with the larger surface area flat on the water because the weight (pressure on the water) is distributed over a larger area and a larger body is presented to buoyancy. Whereas, when turned in a different direction, perhaps vertically, the object will sink, because all the weight is then directed on a small area, and only a small body surface is presented to buoyancy.

Therefore, since different depths of water have different densities, orally ingestible nutriments or medicaments may be formulated to sink into water and have a density which matches a particular depth of the water to be neutrally buoyant at that depth. In formulating a composition for suspension in the drinking water for land animals, the density of the water will need to be determined, and food or medicine particles may then be formulated to match that density so that the food or medicine will disperse into and remain suspended in the water. Similarly, if it is known that a particular breed of fish feeds at a particular depth in its environment, the density of the water at that depth in that environment will need to be determined, and food or medicine particles may then be formulated to match that density so that the food or medicine will disperse into and remain suspended in the water at the desired depth. Some examples of different species of fish and their preferred feeding depths include: fingerlings of salmon and trout which may prefer to feed just below the surface at only a few centimeters depth; tilapia, oreochromis, sarotherodon, carp and perch which may prefer feeding at around 2 meters; and adult cod, salmon or tuna which may prefer to feed at deeper depths which may be between about 8 to about 30 meters.

In some instances, as depicted in FIG. 2, more than one species of fish may be farmed in the same environment with each species having its own preferred feeding depth. Alternatively, for a single species, the fingerlings may prefer to feed at shallow depths and may require a first type of food, while fully grown fish may prefer deeper depths and may require a second type of food. The density of the water will then need to be determined at each of the corresponding depths, and the foods or medicines 10, 12 may then be formulated to match each density so that the foods or medicines will disperse into and remain suspended in the water at each of the desired depths.

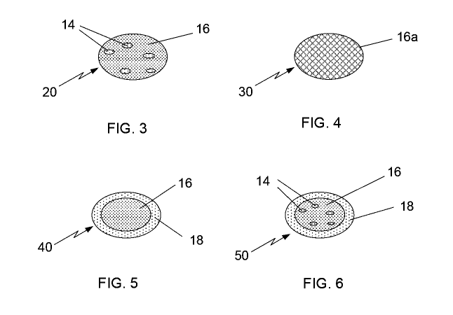

In an embodiment as depicted in FIG. 3, a nutriment or medicament 20 may be formulated to have a particular buoyancy by inclusion of a floating agent 14, which may be a positively buoyant material to offset the typically negative buoyancy of the food or medicine components 16.

Some examples of nutrient sources which may be present in the food component 16 of an ingestible composition 20 include, but are not limited to, carbohydrates, fats, proteins, amino acids, vitamins, minerals, water, nitrogen and oxygen. As an example, a food formulation may include about 32% protein, about 8.5-9.5 Kcal dietary energy per gram of protein, about 5% fats, about 20-35% carbohydrates, less than about 4% fiber, and about 50 ppm vitamin C.

Some nutrient, or food sources, may be obtained by grinding and mixing together ingredients such as fishmeal, vegetable proteins and binding agents such as wheat. Exemplary densities of food components may be about 1.05 g/cm³ to about 1.15 g/cm³. The density of the food component may be about 1.050, about 1.055, about 1.060, about 1.065, about 1.070, about 1.075, about 1.080, about 1.085, about 1.090, about 1.095 about 1.100, about 1.105, about 1.110, about 1.115, about 1.120, about 1.125, about 1.130, about 1.135, about 1.140, about 1.145, about 1.150, or any value between any two of the listed values.

Some examples of ingestible buoyancy materials 14 include, but are not limited to, foam, hydrogel, ground corn cobs, ground cellulose materials, carbamate material, a lignin, and bagasse. Several of these materials may be obtained from waste streams, from which they are the resultant waste of other production processes. For example, bagasse is a waste stream product from sugar cane or sorghum processing as well as waste from date palms, dry herb, or olive oil processing, and lignin is a waste stream product from paper production. Exemplary densities of buoyancy components may be about 0.8 g/cm³ to about 0.95 g/cm³. The density of the buoyancy materials may be about 0.800, about 0.805, about 0.810, about 0.815, about 0.820, about 0.825, about 0.830, about 0.835, about 0.840, about 0.845, about 0.850, about 0.855, about 0.860, about 0.865, about 0.870, about 0.875, about 0.880, about 0.885, about 0.890, about 0.895, about 0.900, about 0.905, about 0.910, about 0.915, about 0.920, about 0.925, about 0.930, about 0.935, about 0.940, about 0.945, about 0.950, or any value between any two of the listed values.

In various embodiments, the component 16 may be a nutritional component, a medicinal component, or a combination of both medicinal components and nutritional components.

In an embodiment used for aquaculture, the nutriment or medicament 20 may contain a medicine component 16 which may contain drugs for treating fish diseases, either singly or in combination with one or more other drugs. The drugs may be usable for treating diseases or parasite infections, which may include: bacterial hemorrhagic septicemia, pseudomonas fluorescens, vibrio, furunculosis, enteric red mouth, streptococcus iniae, bacterial gill disease, tuberculosis, and chlamydial infection.

In an embodiment as depicted in FIG. 4, the density and therefore buoyancy of the ingestible component 30 may be altered by adding a surfactant to the food or medicine component, followed by a rapid mixing to form a foam 16a of the food or medicine component. The density may thereby be decreased to give the ingestible component 30 more positive buoyancy. The amount of foaming may be controlled to give a desirable final density which matches the density of the water, or more particularly, the density of the water at a predetermined depth.

In an ingestible food source 20, the food component 16 may have a density which is greater than that of the water, and a buoyancy component 14 may be added which has a density that is less than the density of the water, in an amount which provides an overall density which is equal to that of the water, and if desirable, matches a particular density at a desired depth of the water. This may be expressed by the following equation

$$( \frac{{m}_{fc}}{{m}_{fc} + {m}_{bc}} ) * {d}_{fc} + ( \frac{{m}_{bc}}{{m}_{fc} + {m}_{bc}} ) * {d}_{bc} = {d}_{as}$$

wherein (dₐₛ) is the density of the aqueous solution, (m_{fc}) is the mass of the food component, (d_{fc}) is the density of the food component, (m_{ba}) is the mass of the buoyancy component, and (d_{bc}) is the density of the buoyancy component. Alternatively, if the food component 16 would have a density which is less than the density of water, a buoyancy component 14 having a density greater than the density of the water may be added to match the overall density to that of the water.

In an embodiment as depicted in FIG. 5, the nutriment or medicament 40 may be encapsulated with an exterior coating 18, and the material used for encapsulating the nutriment or medicament may also provide at least a portion of the positive buoyancy. The encapsulation may also provide a mask for hiding unfavorable odors and/or tastes of the food or medicine component 16. In an embodiment, the coating 18 may also contain flavorings, odorants and/or colorants to make the compositions more appealing to the animals to which they are intended.

In some formulations, the exterior coating 18 may provide all of the opposing buoyancy needed to offset the buoyancy of the food or medicine component 16, in which case, the density and amount of the exterior coating component would be substituted in the above equation for the density and the amount of the buoyancy component. Alternatively as depicted in FIG. 6, the buoyancy component 14 may be added along with the exterior coating 18, to oppose the buoyancy of the food or medicine component 16, in which case, the relative amounts may be calculated by the equation

$$( \frac{{m}_{fc}}{{m}_{fc} + {m}_{bc} + {m}_{ec}} ) * {d}_{fc} + ( \frac{{m}_{bc}}{{m}_{fc} + {m}_{bc} + {m}_{ec}} ) * {d}_{bc} + ( \frac{{m}_{ec}}{{m}_{fc} + {m}_{bc} + {m}_{ec}} ) * {d}_{ec} = {d}_{as}$$

wherein (dₐₛ) is the density of the aqueous solution, (m_{fc}) is the mass of the food component, (d_{fc}) is the density of the food component, (m_{bc}) is the mass of the buoyancy component, (d_{bc}) is the density of the buoyancy component, (m_{ec}) is the mass of the exterior coating component and (d_{ec}) is the density of the exterior coating component.

The exterior coating 18 may be made from a gelling composition. Some examples of gelling compositions may include, but are not limited to, lignins, glucosides, a lignin/chitosan/chondroitin hydrogel, a lignocellulose/chondroitin hydrogel, a lignin-methylol/amino acid hydrogel, agar, sodium alginate, starch, carboxymethylcellulose, carboxyethylcellulose, hydroxymethylcellulose, hydroxyethylcellulose, keratin hydrogels, foaming hydrogels, a whey hydrogel, sucrose waste hydrogel, gelatin from meat processing, keratin from meat processing, chondrin from meat processing, or combinations thereof. Some of these coating may be tasteless, while others, such as lignins and glucosides have a slightly sweet taste which may be desirable for some food products. In some embodiments, the hydration state of the gelling compositions may affect the buoyancy of the gelling composition. The gelling composition may have an initial buoyance when first dispersed into water, but over time, as the gel takes up more water, the buoyancy may also change, and appropriate consideration in calculation of the food buoyancy may need to include this factor as well.

In some formulations, a cross-linking agent may be needed in the coating, depending on the coating composition. Some examples of crosslinking agents which may be used include, but are not limited to, EDNA, methylol urea, dimethyl urea, bus-vanillin ether, inorganic crosslinking agents, or heat, or combinations thereof. Due to the extensive cross-linking, the coating may not be absorbed into the food or medicinal component but may stay essentially on the surface, forming a layer that is breathable, thin and transparent. The coating may also give the finished product some flexibility to withstand mechanical stresses which may occur during transport.

Exemplary densities of exterior coatings may be about 1.0 g/cm³ to about 1.1 g/cm³. The density of the exterior coatings may be about 1.00, about 1.005, about 1.010, about 1.015, about 1.020, about 1.025, about 1.030, about 1.035, about 1.040, about 1.045, about 1.050, about 1.055, about 1.060, about 1.065, about 1.070, about 1.075, about 1.080, about 1.085, about 1.090, about 1.095, about 1.100, or any value between any two of the listed values.

With the inclusion of an exterior coating 18, that essentially seals the food or medicine component 16 within an encapsulating material, the source of the nutrition, or food component, may be expanded to feedstock which is typically not used because fish find them disagreeable either through smell or taste. For example, several waste streams which are rich in nitrogen, protein and carbon may provide suitable food sources if the flavor is masked, and/or a more agreeable flavoring and/or odorant is added to the coating. Some examples of waste streams which may provide appropriate nutritional sources include, but are not limited to, animal excrement, human excrement, waste vegetable matter, municipal solid waste, abattoir (slaughterhouse) waste, fish processing waste, or a combination thereof.

The total nutrient content of any foods produced with a buoyancy component, an exterior coating, or both, should therefore take into consideration the nutritional value, if any, of any buoyancy components and/or exterior coating components. Exact formulations of resultant ingestible nutriments or medicaments would depend on the type of animal being fed, the stage of development of the animal, known nutritional and/or medical deficiencies, desired supplementations, and/or the like.

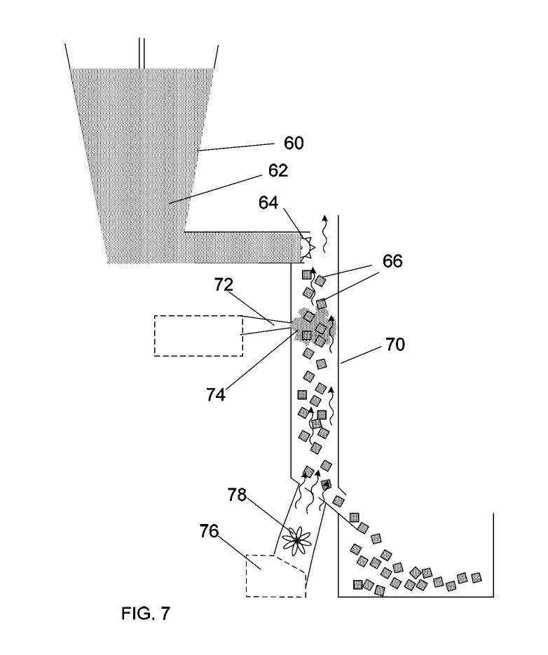

An exemplary system for producing a neutrally buoyant animal food is represented by the system depicted in FIG. 7. The desired density of the food and the nutritional makeup may be determined. A calculated amount of nutritional components, such as fishmeal, vegetable proteins, etc., may be mixed in a hopper 60 with a calculated amount of a buoyancy material, such as ground corn cobs, ground cellulose materials, a foaming agent, etc., and an amount of a fluid, such as water, to make a paste 62.

After the ingredients are thoroughly combined, the paste may be extruded and pelletized at a processing device 64 to pellets 66 of a size which may be determined on the basis of preferred sizes for the animal for which the food is intended. Smaller fish, such as perch for example, may prefer food sizes of about 2 mm cross-section, while larger fish, such as carp, for example, may prefer a food size of about 2 cm cross-section. As mentioned previously, the size may also need to be taken into consideration when determining the final buoyancy. These sizes are intended as examples only, and sizes may be of any size from about 1 mm to about 3-4 cm in cross-section, or larger depending on the preferences for the various animals which will be fed.

As an alternative to extruding pellets, the paste may also be formed into sheets, dried and then cut or broken into pieces. Other types of processes may also be used for forming particle, or pellet shaped pieces of the food.

As depicted in FIG. 7, the processing system may be essentially unified, and after the pellets 66 are formed, the pellets may fall downwardly though a shaft 70 which includes an outlet nozzle 72 for spraying an encapsulating substance 74, such as a hydrogel, into the shaft. As the pellets 66 fall downwardly through the spray of encapsulating substance 74 they receive an exterior coating as previously discussed. If necessary, the encapsulating substance may also include a crosslinking agent. To seal the encapsulation, the saft 70 may include a heat source 76 with a blower 78 to blow heated air upwardly through the shaft. The heated air in the vicinity below the encapsulating spray may be about 50° C. to about 90° C. to begin an initial setting of the encapsulating substance. The pellets 66 may then continue downwardly through the heated air to fully seal the encapsulation, and essentially ensure that the coating is dry prior to packaging.

This arrangement also allows for the upward flow of air to be adjusted to vary the amount of time that the falling pellets may be in the heated air. An increased airflow may hinder the gravitational pull and slow the rate of falling. Alternative processing arrangements may also be used for forming food particles. These arrangements may include alternative coating processes such as immersion, conveyors, alternate drying sources such as microwaves, and/or the like.

The resultant product pellets 66 may be packaged and sold as individual feed components, for example in a feeding kit. Products may also be pre-made and sold in bulk form as a function of their size, nutritional content, and density. A farmer with the knowledge of the particular nutritional requirements needed for a specific breed of fish and the density of the water at the feeding depth may then purchase from a bulk supply a desired quantity of a feed. Alternatively, feed products may be specially made to meet a particular customer's requirements.

For farms which raise more than one species of fish in an enclosed area, or have a single species at different growth stages, a kit may be provided which includes a food source for each of the fish that is being farmed, or for each developmental stage. As an example, there may be two, or possibly more, different species of fish farmed in a tank, with each species having its own preferred feeding depth and/or nutritional requirements. The kit may then contain a first food that has a first density for suspension at a first feeding depth for a first species of fish, a second food that has a second density for suspension at a second feeding depth for a second species of fish, and any additionally configured foods as needed. The foods may be intermixed at a pre-determined ratio taking into consideration the amounts of each needed and dispersed as a mix from a single source onto the habitat water. Because of the configured densities, the foods settle into the tank water to the appropriate depths for feeding.

For land animals, such as cattle, the disclosed food sources (or medicaments) may be dispersed onto provided drinking water. The food sources may settle into the water and remain suspended in the water to be consumed when the animal drinks the water. Thus, in times of excessive heat when cattle or other animals may prefer to drink more water and eat less food, the cattle may still receive adequate nutrition for growth, or to at least maintain their weight and health.

### EXAMPLE 1

### Neutrally Buoyant Fish Food

A nutrient component (16 in FIG. 6) will be prepared by first enhancing water with a vitamin mix having vitamin A, vitamin D, vitamin E, vitamin K₃, vitamin B₁, vitamin B₂, vitamin B₆, vitamin B₁₂, Niacin, Pantothenic acid, Folic acid, Biotin, inositol, vitamin C and a preservative such as Naturox® from Kemin Industries Inc. (Des Moines, Iowa). Animal excrement will be obtained and placed in a mixing container with an amount of the enhanced water sufficient to form a paste. The mixture will be blended thoroughly with a mixer. A mixture of wheat and potato grains totaling about 10% to about 20% by weight of the wet mix will be added. The mixture will be blended again and then pumped to a grinder emulsifier to reduce the particle size and ensure that the vitamins and preservatives are thoroughly mixed in.

The resultant nutrient component will be placed in a mixing hopper (60 in FIG. 7), and will be mixed with ground cellulosic waste, such as ground wheat straw, as the density/floating controlling agent (14 in FIG. 6). The amount of the cellulosic waste will be determined based on the required density in accordance with the earlier presented equations. Additional water will be added, if necessary, to provide a thick paste.

The paste will be extruded to squeeze out extra water and compress the mixture through an opening of about 4 mm cross-section. The extrudate will be cut into desired lengths of about 4 mm, and the resultant pellets will be dispersed into a heated column of air in a shaft (70 in FIG. 6) where they will be sprayed with a coating containing Lignin-chitosan-chondroitin natural hydrogel and the crosslinking agent bis-vanillin ether produced from lignin oxidation. This will encapsulate the nutritional component (16 in FIG. 6) with a coating (18 in FIG. 6). The hydrogel will be in an amount of about 1% to about 6% of the total weight of the food component, and the cross-liking agent will be in an amount of about 1% to about 2% of the total weight of the food component.

Heated air at about 70 ° C. will cure the coating as the pellets fall through the shaft to produce a resultant product which will not stick together and may be ready to be immediately packaged for storage and sale.

With this example, if the food component has a density of 1.05 g/cm³, the exterior coating has a density of 1.00 g/cm³, the buoyancy component has a density of 0.8 g/cm³, and a spray coating provides about 2% of the total mass, the calculations would be as follows for a water density of 1.0011 g/cm³.

%_{fc}+%_{bc}+%_{ec}=100%, so %_{fc}+%_{bc}+2%=100%, or %_{fc}=98%−%_{bc}

ps
Then, using the equation as provided above:

$$( \frac{{m}_{fc}}{{m}_{fc} + {m}_{bc} + {m}_{ec}} ) * {d}_{fc} + ( \frac{{m}_{bc}}{{m}_{fc} + {m}_{bc} + {m}_{ec}} ) * {d}_{bc} + ( \frac{{m}_{ec}}{{m}_{fc} + {m}_{bc} + {m}_{ec}} ) * {d}_{ec} = {d}_{as}$$

$${\%}_{fc} * 1.05 + {\%}_{bc} * 0.80 + 0.02 * 1.00 = 1.0011$$

$$( 0.98 - {\%}_{bc} ) * 1.05 + {\%}_{bc} * 0.80 + 0.02 * 1.00 = 1.0011 or , \\ {\%}_{bc} = 0.19 , or 19 \% .$$

The fish food pellets will therefore require a mixture of 79% of the nutrient component and 19% of the buoyancy component.

### EXAMPLE 2

### A Fish-Feeding Method

The fish food prepared in accordance with Example 1 will be used for feeding at a fish farm which raises catfish. The lake water density is typically about 1.0011 g/cm³. The catfish may have an average weight of about 180 g and require a ration of about 2.5% of its weight per day. Each catfish will therefore require about 4.5 g of food per day. The fish are fed twice a day and therefore about 2.25 g/fish will be required at each feeding. If the farm has an estimate of about 1000 fish, 2.25 kg of feed will be weighed out and distributed onto the water at each feeding. Since the food has a density which matches the water density, the food will sink under the water surface and remain buoyant in the water for consumption by the fish.

### EXAMPLE 3

### A Fish Food Kit and Feeding Method

A fish food kit will be prepared for a fish farm which raises two different species of fish that prefer feeding at different depths. As an example the farm may raise silver carp (Hypophthalmichthys molitrix) which prefer to feed at about 0-1 meters, and which will consume about 30% of the food, and also raise rohu (Labeo rohita) which prefer to feed at about 2-4 meters, and which will consume about 70% of the food.

A customized food mixture for that particular fish farm will be prepared from two different density food pellets made in a manner similar to the procedure set forth in Example 1. The mixture will contain about 30% of a first food pellet nutritionally formulated for the silver carp and having a density of about 1.0005 g/cm³ for remaining near the surface, and about 70% of a second food pellet nutritionally formulated for the rohu and having a density of about 1.001 g/cm³ for sinking to the deeper feeding level. The food will be provided as a 30%/70% mix in 25 kg bags and will require no further mixing for distribution at the farm.

At the appropriate feeding time, a predetermined quantity of the feed will be measured out and dispersed onto the lake water. The first portion (30%) of the feed having the lower density will sink into the water just below the surface of the water and remain suspended at that depth for feeding the silver carp. The second portion (70%) of the feed having the higher density will sink into the water to the lower depth and remain suspended at the lower depth for consumption by the rohu. Without any additional measuring and/or mixing, each species of fish will receive an appropriate amount of a food which has an appropriate nutritional formulation for that fish.

This disclosure is not limited to the particular systems, devices and methods described, as these may vary. The terminology used in the description is for the purpose of describing the particular versions or embodiments only, and is not intended to limit the scope.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially of” or “consist or the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases ^{at} ₗₑₐₛₜ ^{one} and “one or ^{more} to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g.,“a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A solid ingestible composition for being dispersed in an aqueous solution, and suspended at a depth below a surface of the aqueous solution, the aqueous solution having a density (dₐₛ) at the suspension depth, and the ingestible composition comprising:
at least one of a nutriment and a medicament having a density (d_{fc}); and
a buoyancy component comprising a food grade material having a density (d_{bc}),
wherein a mass (m_{bc}) of the buoyancy component is configured in relation to a mass (m_{fc}) of the at least one of the nutriment and the medicament such that:
$$\frac{{m}_{fc} * {d}_{fc}}{{m}_{fc} + {m}_{bc}} + \frac{{m}_{bc} * {d}_{bc}}{{m}_{fc} + {m}_{bc}} = {d}_{as}$$
for buoyantly suspending the ingestible composition at the depth below the surface of the aqueous solution.

2. (canceled)

3. The ingestible composition of claim 1, wherein the ingestible composition is at least one of aquatic animal food and a nutritional supplement for terrestrial animals.

4. (canceled)

5. The ingestible composition of claim 1, wherein:
the aqueous solution is a water habitat for at least one species of fish, the water habitat defining at least two density layers with a first lighter density layer near the surface and a second heavier density layer under the first layer;
the ingestible composition is fish food for the at least one species of fish;
the at least one species of fish has a preferred feeding depth below the surface of the water at one of a depth in the first density layer and a depth in the second density layer; and
the fish food is configured to have a density for buoyantly suspending the fish food at the preferred feeding depth.

6. (canceled)

7. The ingestible composition of claim 5, wherein:
the first density layer has a density less than or equal to about 1.0015 g/cm3 and the at least one species of fish comprises at least one of tilapia, oreochromis, sarotherodon, carp and perch; and
the second density layer has a density greater than or equal to about 1.0015 g/cm3 and the at least one species of fish comprises at least one of cod, tuna and salmon.

8-10. (canceled)

11. The ingestible composition of claim 1, wherein:
the aqueous solution has a density of about 1.00 g/cm³ to about 1.05 g/cm³;
the at least one of a nutriment and a medicament comprises any combination of any of carbohydrates, fats, proteins, amino acids, vitamins, minerals, water, nitrogen, and oxygen, and the density of the at least one of a nutriment and a medicament is greater than the density of the aqueous solution and about 1.05 g/cm³ to about 1.15 g/cm³; and
the buoyancy component comprises at least one of foam, hydrogel, ground corn cobs, ground cellulose materials, carbamate material, a lignin, and bagasse, and the density of the buoyancy component is has a density less than the density of the aqueous solution and about 0.80 g/cm³ to about 0.95 g/cm³.

12-17. (canceled)

18. The ingestible composition of claim 1, wherein:
the buoyancy component is an exterior coating disposed about and encasing the at least one of the nutriment and the medicament.

19. The ingestible composition of claim 18, wherein the coating comprises at least one of:
a composition for masking at least one of a flavor and a smell of the at least one of the nutriment and the medicament;
flavoring;
odorant; and
colorant.

20-21. (canceled)

22. The ingestible composition of claim 1, wherein:
the ingestible composition further comprises an exterior coating disposed about and encasing the buoyancy component and the at least one of the nutriment and the medicament, the exterior coating having a mass (m_{ec}), and a density (d_{ec}) of about 1.0 g/cm³ to about 1.1 g/cm³;
the buoyancy component has a density of about 0.80 g/cm³ to about 0.95 g/cm³;
the aqueous solution has a density of about 1.00 g/cm³ to about 1.05 g/cm³;
the first component has a density of about 1.05 g/cm³ to about 1.15 g/cm³; and
the mass (m_{bc}) of the buoyancy component being configured in relation to the mass (m_{fc}) of the at least one of the nutriment and the medicament and the mass (m_{ec}) of the exterior coating such that:
$$\frac{{m}_{fc} * {d}_{fc}}{{m}_{fc} + {m}_{bc} + {m}_{ec}} + \frac{{m}_{bc} * {d}_{bc}}{{m}_{fc} + {m}_{bc} + {m}_{ec}} + \frac{{m}_{ec} * {d}_{ec}}{{m}_{fc} + {m}_{bc} + {m}_{ec}} = {d}_{as}$$
to provide the density for buoyantly suspending the ingestible composition at the suspension depth.

23-26. (canceled)

27. The ingestible composition of claim 22, wherein the coating comprises at least one of a gelling composition and a crosslinking agent.

28. The ingestible composition of claim 27, wherein:
the at least one of the nutriment and the medicament comprises a food component comprising at least one of carbohydrates, fats, proteins, amino acids, vitamins, minerals, water, nitrogen and oxygen;
the buoyancy component comprises at least one of foam, hydrogel, ground corn cobs, ground cellulose materials, carbamate material, a lignin, and bagasse;
the gelling composition comprises a lignin/chitosan/chondroitin hydrogel, a lignocellulose/chondroitin hydrogel, a lignin-methylol/amino acid hydrogel, agar, sodium alginate, starch, carboxymethylcellulose, carboxyethylcellulose, hydroxymethylcellulose, hydroxyethylcellulose, keratin hydrogels, foaming hydrogels, a whey hydrogel, sucrose waste hydrogel, gelatin from meat processing, keratin from meat processing, or chondrin from meat processing or combinations thereof; and
the crosslinking agent comprises EDTA, methylol urea, dimethylol urea, bis-vanillin ether, inorganic crosslinking agents, or heat, or combinations thereof.

29. (canceled)

30. The ingestible composition of claim 22, wherein:
the buoyancy component comprises at least one of:
a foam produced from rapid mixing of the food component with a surfactant: and
recycled waste stream products; and
the at least one of the nutriment and the medicament comprises a nutrient source from animal excrement, human excrement, waste vegetable matter, municipal solid waste, or a combination thereof.

31-37. (canceled)

38. A kit for aquatic animal farming of at least first and second aquatic animal species, the kit comprising:
a first food for the first aquatic animal species, the first aquatic animal species having a preferred first feeding depth below the surface of the water, the water having a first density (d1ₐₛ) at the first feeding depth;
a second food for the second aquatic animal species, the second aquatic animal species having a preferred second feeding depth below the surface of the water, the second depth being different from the first depth, and the water having a second density (d2ₐₛ) at the second feeding depth, the second density being different from the first density;
the first food being configured to have a first density for buoyantly suspending the first food at the first depth, the first food comprising:
a mass (m1_{fc}) of a first food component having a density (d1_{fc}), and
a mass (m1_{bc}) of a first buoyancy component having a density (d1_{bc}), such that:
$$\frac{m {1}_{fc} * d {1}_{fc}}{m {1}_{fc} + m {1}_{bc}} + \frac{m {1}_{bc} * d {1}_{bc}}{m {1}_{fc} + m {1}_{bc}} = d {1}_{as} ;$$
the second food being configured to have a second density for buoyantly suspending the second food at the second depth, the second food comprising:
a mass (m2_{fc}) of a second food component having a density (d2_{fc}), and
a mass (m2_{bc}) of a second buoyancy component having a density (d2_{bc}) such that:
$$\frac{m {2}_{fc} * d {2}_{fc}}{m {2}_{fc} + m {2}_{bc}} + \frac{m {2}_{bc} * d {2}_{bc}}{m {2}_{fc} + m {2}_{bc}} = d {2}_{as} ;$$
the first food component is the same as or different from the second food component; and
the first buoyancy component is the same as or different from the second buoyancy component.

39-41. (canceled)

42. The kit of claim 38, wherein:
the first density of the aqueous solution is about 1.00 g/cm³ to about 1.05 g/cm³;
the second density of the aqueous solution is greater than the first density of the aqueous solution and is about 1.00 g/cm³ to about 1.05 g/cm³;
each of the first and second food components individually has a density of about 1.05 g/cm³ to about 1.15 g/cm³; and
each of the first and second buoyancy components individually has a density of about 0.80 g/cm³ to about 0.95 g/cm³.

43-46. (canceled)

47. The kit of claim 38, wherein:
the first food additionally comprises a first exterior coating disposed about and encasing the first food component and the first buoyancy component, the first exterior coating comprising a composition for masking at least one of a flavor and a smell of at least one of the first food component and the first buoyancy component; and
the second food additionally comprises a second exterior coating disposed about and encasing the second food component and the second buoyancy component, the second exterior coating comprising a composition for masking at least one of a flavor and a smell of the second food component and the second buoyancy component.

48-49. (canceled)

50. The kit of claim 47, wherein:
the first food additionally comprises:
an amount (m1_{bc}) of a the first buoyancy component having a density (d2_{bc}), such that:
$$\frac{m {1}_{fc} * d {1}_{fc}}{m {1}_{fc} + m {1}_{bc} + m {1}_{ec}} + \frac{m {1}_{bc} * d {1}_{bc}}{m {1}_{fc} + m {1}_{bc} + m {1}_{ec}} + \frac{m {1}_{ec} * d {1}_{ec}}{m {1}_{fc} + m {1}_{bc} + m {1}_{ec}} = d {1}_{as} ;$$
and the second food additionally comprises:
an amount (m2_{bc}) of a second buoyancy component having a density (d2_{bc}), such that:
$$\frac{m {2}_{fc} * d {2}_{fc}}{m {2}_{fc} + m {2}_{bc} + m {2}_{ec}} + \frac{m {2}_{bc} * d {2}_{bc}}{m {2}_{fc} + m {2}_{bc} + m {2}_{ec}} + \frac{m {2}_{ec} * d {2}_{ec}}{m {2}_{fc} + m {2}_{bc} + m {2}_{ec}} = d {2}_{as} .$$

51. The kit of claim 50, wherein:
the first density of the aqueous solution is about 1.00 g/cm³ to about 1.05 g/cm³;
the second density of the aqueous solution is greater than the first density of the aqueous solution and is about 1.00 g/cm³ to about 1.05 g/cm³;
each of the first and second food components has a density of about 1.05 g/cm³ to about 1.15 g/cm³;
each of the first and second buoyancy components has a density of about 0.80 g/cm³ to about 0.95 g/cm³; and
each of the first and second exterior coatings has a density of about 1.0 g/cm³ to about 1.1 g/cm³.

52. A method for producing a solid ingestible composition for being suspended in an aqueous solution at a depth below the surface of the aqueous solution, the method comprising:
determining a density of the aqueous solution at the suspension depth; and
forming the ingestible composition of at least:
a first component comprising at least one of a nutriment and a medicament, the first component having a first density greater than the density of the aqueous solution at the suspension depth; and
a buoyancy component comprising a food grade material having a second density less than the density of the aqueous solution at the suspension depth; and
mixing an amount of the first component with an amount of the second component to produce an ingestible composition having a density equal to the density of the aqueous solution at the suspension depth for buoyantly suspending the ingestible composition at the suspension depth.

53-54. (canceled)

55. The method of claim 52, wherein:
the aqueous solution has a density (dₐₛ) of about 1.00 g/cm³ to about 1.05 g/cm³ at the suspension depth;
the first component has a density (d_{fc}) of about 1.05 g/cm³ to about 1.15 g/cm³; and
the buoyancy component has a density (d_{bc}) of about 0.80 g/cm³ to about 0.95 g/cm³;
the mixing further comprises forming a first mixture having a mass (m_{fc}) of the first component and a mass (m_{bc}) of the buoyancy component so that
$$\frac{{m}_{fc} * {d}_{fc}}{{m}_{fc} + {m}_{bc}} + \frac{{m}_{bc} * {d}_{bc}}{{m}_{fc} + {m}_{bc}} = {d}_{as} ,$$
and
the method further comprises forming portions of the first mixture into food portions.

56. The method of claim 55, wherein the forming portions of the first mixture into food portions comprises at least one of:
A) extruding the first mixture to form an extrudate;
portioning the extrudate into the food portions; and
drying the food portions:
B) forming a sheet of the first mixture;
drying the sheet of the first mixture; and
dividing the sheet of the first mixture into the food portions; and
C) forming a sheet of the first mixture;
forming shaped food portions of the sheet of the first mixture; and
drying the shaped food portions.

57-59. (canceled)

60. The method of claim 55, wherein:
the ingestible composition further comprises an amount (m_{ec}) of an exterior coating disposed about and encasing the food component and the buoyancy component and having a density (d_{ec}) of about 1.0 g/cm³ to about 1.1 g/cm³; and
the method further comprises:
determining the amount of the buoyancy component needed in relation to the amount of the first component and the amount of the exterior coating such that:
$$\frac{{m}_{fc} * {d}_{fc}}{{m}_{fc} + {m}_{bc} + {m}_{ec}} + \frac{{m}_{bc} * {d}_{bc}}{{m}_{fc} + {m}_{bc} + {m}_{ec}} + \frac{{m}_{ec} * {d}_{ec}}{{m}_{fc} + {m}_{bc} + {m}_{ec}} = {d}_{as} , ;$$
coating the food portions with the exterior coating.

61-63. (canceled)

64. The method of claim 60, wherein:
the forming portions of the first mixture into food portions comprises:
extruding the first mixture to form an extrudate, and
portioning the extrudate into pellets; and
the method further comprises:
dispersing the pellets into a column of rising heated air, wherein the pellets fall downwardly through the rising heated air,
applying the exterior coating by spraying the pellets with the exterior coating as the pellets fall through the rising heated air, and
drying the pellets as the pellets fall through the rising heated air.

65. The method of claim 64, wherein:
the first component comprises at least one of carbohydrates, fats, proteins, amino acids, vitamins, minerals, water, nitrogen and oxygen;
the buoyancy component comprises a food grade material comprising at least one of foam, hydrogel, ground corn cobs, ground cellulose materials, carbamate material, a lignin, and bagasse;
the first component and the buoyancy component have a first flavor, a first odor, and a first color;
the coating comprises a digestible exterior coating configured to hide the first flavor, hide the first odor, hide the first color, add a second flavor different from the first flavor, add a second odor different from the first odor, or add a second color different from the first color, or a combination thereof; and
the coating comprises:
a gelling composition comprising a lignin/chitosan/chondroitin hydrogel, a lignocellulose/chondroitin hydrogel, a lignin-methylol/amino acid hydrogel, agar, sodium alginate, starch, carboxymethylcellulose, carboxyethylcellulose, hydroxymethylcellulose, hydroxyethylcellulose, keratin hydrogels, foaming hydrogels, a whey hydrogel, sucrose waste hydrogel, gelatin from meat processing, keratin from meat processing, chondrin from meat processing or a combination thereof: and
a crosslinking agent comprising EDTA, methylol urea, dimethylol urea, bis-vanillin ether, inorganic crosslinking agents, heat, or a combination thereof.

66. (canceled)

67. The method of claim 52, wherein:
the aqueous solution has a density (dₐₛ) at the suspension depth;
the first component has a density (d_{fc})
the buoyancy component is an exterior coating disposed around and encasing the first component, the exterior coating having a density (d_{ec}); and
the forming the ingestible composition further comprises:
determining a mass (m_{ec}) of the exterior coating needed in relation to a mass (m_{fc}) of the first component so that
$$\frac{{m}_{fc} * {d}_{fc}}{{m}_{fc} + {m}_{ec}} + \frac{{m}_{ec} * {d}_{ec}}{{m}_{fc} + {m}_{ec}} = {d}_{as} ,$$
forming the first component into food portions having the mass (m_{fc}), and
applying the determined mass (m_{ec}) of the exterior coating around the food portions to enclose the first component.

68-69. (canceled)

70. A method for providing nourishment to animals, the method comprising:
determining a density of an aqueous solution;
configuring at least a first solid ingestible component for dispersion into the aqueous solution, the configuring comprising forming the first solid ingestible component of at least:
a mass of a food component comprising at least one of a nutriment and a medicament, the first component having a first density greater than the density of the aqueous solution at the suspension depth; and
a mass of a buoyancy component comprising a food grade material having a second density less than the density of the aqueous solution at the suspension depth, so that the first solid ingestible component has a density equal to the density of the aqueous solution to buoyantly suspend the first solid ingestible component within the aqueous solution;
and
dispersing the first solid ingestible component in the aqueous solution for ingestion of the first solid ingestible component by the animals.

71. The method of claim 70, wherein the aqueous solution is drinking water for terrestrial animals and the method comprises:
dispersing the first solid ingestible component into the drinking water to buoyantly suspend the first solid ingestible component in the drinking water; and
presenting the drinking water to the terrestrial animals for consumption of the drinking water and the suspended first solid ingestible component.

72. (canceled)

73. The method of claim 70, wherein:
the aqueous solution is habitat water for supporting at least first and second aquatic animal species therein, the first aquatic animal species having a first preferred feeding depth and the second aquatic animal species having a second preferred feeding depth different from the first depth, the aqueous solution has a first density (d1ₐₛ) at the first feeding depth and a second density (d2ₐₛ) at the second feeding depth;
the at least a first solid ingestible component comprises:
a first solid ingestible component configured to have a first density for buoyantly suspending the first solid ingestible component at the first depth, the first solid ingestible component comprises:
a mass (m1_{fc}) of a first food component having a density (d1_{fc}),
a mass (m1_{ec}) of a first exterior coating having a density (d1_{ec}), and
a mass (m1_{bc}) of a first buoyancy component having a density (d2_{bc}), such that
$$\frac{m {1}_{fc} * d {1}_{fc}}{m {1}_{fc} + m {1}_{bc} + m {1}_{ec}} + \frac{m {1}_{bc} * d {1}_{bc}}{m {1}_{fc} + m {1}_{bc} + m {1}_{ec}} + \frac{m {1}_{ec} * d {1}_{ec}}{m {1}_{fc} + m {1}_{bc} + m {1}_{ec}} = d {1}_{as} ;$$
and
a second solid ingestible component configured to have a second density for buoyantly suspending the second solid ingestible component at the second depth, the second ingestible component comprises:
a mass (m2_{fc}) of a second food component having a density (d2_{fc}),
a mass (m2_{ec}) of a second exterior coating having a density (d2_{ec}), and
a mass (m2_{bc}) of a second buoyancy component having a density (d2_{bc}), such that
$$\frac{m {2}_{fc} * d {2}_{fc}}{m {2}_{fc} + m {2}_{bc} + m {2}_{ec}} + \frac{m {2}_{bc} * d {2}_{bc}}{m {2}_{fc} + m {2}_{bc} + m {2}_{ec}} + \frac{m {2}_{ec} * d {2}_{ec}}{m {2}_{fc} + m {2}_{bc} + m {2}_{ec}} = d {2}_{as} ;$$
and
the method further comprises dispersing the first solid ingestible component and the second solid ingestible component into the habitat water, wherein the first solid ingestible component sinks to and becomes suspended at the first depth for feeding the first aquatic animal species and the second solid ingestible component sinks to and becomes suspended at the second depth for feeding the second aquatic animal species.

74. (canceled)

75. The method of claim 73, wherein:
the first density of the aqueous solution is about 1.00 g/cm³ to about 1.05 g/cm³;
the second density of the aqueous solution is greater than the first density of the aqueous solution and is about 1.00 g/cm³ to about 1.05 g/cm³;
each of the first and second food components individually comprises at least one of carbohydrates, fats, proteins, amino acids, vitamins, minerals, water, nitrogen, and oxygen, and each of the first and second food components individually has a density of about 1.05 g/cm³ to about 1.15 g/cm³;
each of the first and second buoyancy components individually comprises a food grade material comprising at least one of foam, hydrogel, ground corn cobs, ground cellulose materials, carbamate material, a lignin, and bagasse, and each of the first and second buoyancy components individually has a density of about 0.80 g/cm³ to about 0.95 g/cm³; and
each of the first and second exterior coatings individually comprises:
a gelling composition comprising a lignin/chitosan/chondroitin hydrogel, a lignocellulose/chondroitin hydrogel, a lignin-methylol/amino acid hydrogel, agar, sodium alginate, starch, carboxymethylcellulose, carboxyethylcellulose, hydroxymethylcellulose, hydroxyethylcellulose, keratin hydrogels, foaming hydrogels, a whey hydrogel, sucrose waste hydrogel, gelatin from meat processing, keratin from meat processing, chondrin from meat processing or a combination thereof; and
a crosslinking agent comprising EDTA, methylol urea, dimethylol urea, bis-vanillin ether, inorganic crosslinking agents, heat, or a combination thereof,
and each of the first and second exterior coatings individually has a density of about 1.0 g/cm³ to about 1.1 g/cm³.

76-77. (canceled)
